(19) United States
(12) Patent Application Publication
(10) Pub. No.: US 2022/0194222 A1
(43) Pub. Date: Jun. 23, 2022

(54) ADJUSTABLE TRANSMISSION SHIFTER

(71) Applicant: THE BRAUN CORPORATION, Winamac, IN (US)

(72) Inventor: Michael T. Zindler, Kalamazoo, MI (US)

(21) Appl. No.: 17/551,579

(22) Filed: Dec. 15, 2021

Related U.S. Application Data
(60) Provisional application No. 63/127,312, filed on Dec. 18, 2020.

(51) Int. Cl. B60K 20/08; B62D 25/20; B60N 2/005; B62D 65/14; A61G 3/08

(52) U.S. Cl. CPC B60K 20/08; B62D 25/20; A61G 3/0808; B62D 65/14; B60N 2/005

(57) ABSTRACT

A transmission shifter for an original equipment manufacturer (OEM) vehicle adapted to transport a physically limited person, wherein a front passenger compartment of the vehicle includes a dash, a driver side compartment, and a passenger side compartment. An OEM vehicle shifter is removed from the vehicle and located on a support slidingly engaging a fixed support located at the dash or behind the dash. The support is disposed between the driver side compartment and the passenger side compartment and is adjustable therebetween to increase clearance between the driver seated in a wheelchair and the vehicle shifter or to increase clearance between the vehicle shifter and a passenger seated in the front passenger compartment.

### RELATED APPLICATIONS

The present application claims the benefit of U.S. Provisional Patent Application Ser. No. 63/127,312, filed Dec. 18, 2020 and entitled “ADJUSTABLE TRANSMISSION SHIFTER,” the disclosure of which is hereby incorporated by reference in its entirety.

### FIELD OF THE DISCLOSURE

The present application relates to a passenger vehicle for transporting one or more passengers, and more particularly to a passenger vehicle which is retrofitted for transporting one or more passengers seated in a wheelchair.

### BACKGROUND

Automobile manufacturers do not currently mass-produce passenger vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by removing certain parts or structures within a vehicle and replacing those with parts or structure specifically designed to accommodate the physically limited passenger. For example, in one configuration a van is retrofitted with a ramp to enable a physically limited individual using a wheelchair to enter the vehicle without the assistance of another individual.

Other known products for retrofitting a vehicle, such as a van, include wheel chair lifts, lift platforms, and lowered floor surfaces. In some instances, a door of an original equipment manufacturer (OEM) van is enlarged or otherwise modified to permit entry of the physically limited individual through what is known as the assisted entrance. Once inside the van, individuals who use the assisted entrance are often located in a rear passenger compartment of the van adjacent to or behind the assisted entrance.

While these seating locations provide for the transport of the physically limited individual, such locations do not always lend themselves to enabling an owner of the vehicle to drive the vehicle, if confined to a wheelchair. In particular, the driver's side position does not lend itself to locating a passenger seated in a wheelchair to drive the vehicle. Consequently, modifications are made to the front passenger area which can include the driver's side compartment and the front passenger compartment. What is needed, therefore, is a modification to an OEM vehicle which allows the physically limited individual seated in a wheelchair to be located in the front passenger compartment, particularly at the driver's side position.

### SUMMARY

In one embodiment there is provided a transmission shifter for a vehicle having a dash. The transmission shifter includes a support assembly coupled to a vehicle support, wherein the support assembly includes a support bracket having one of a slot and rail. A shifter assembly includes a locking mechanism and a front plate including the other of the slot and the rail, wherein the slot engages the rail to enable sliding movement of the shifter assembly with respect to the support assembly. The locking mechanism fixes the location of the shifter assembly with respect to the support assembly.

In some embodiments, the transmission shifter includes wherein the support bracket includes a slot and the locking mechanism includes a latch block located on a first side of the support bracket. A slide block is located on a second side of the support bracket. The locking mechanism adjusts a position of the slide block with respect to the latch block.

In some embodiments, the transmission shifter includes wherein the locking mechanism includes a shaft extending through the slide block, through the slot, and through a tee nut block. Adjustment of the arm adjusts a distance between the slide block and the tee nut block to clamp and unclamp the shifter assembly with respect to the dash.

In some embodiments, the transmission shifter further includes a shifter housing adapted to support a gear shifter coupled to a cable, wherein the support bracket includes a cutout adapted to provide access for the cable.

In some embodiments, the transmission shifter includes wherein the gear shifter is an original equipment manufacturer part.

In some embodiments, the transmission shifter further includes a bracket assembly fixedly connected to the front plate, wherein the bracket assembly is configured to support a shifter mechanism coupled to the gear shifter.

In some embodiments, the transmission shifter further includes a shifter housing connected to the bracket assembly, wherein the shifter housing supports the gear shifter, the shifter mechanism, and the bracket assembly.

In some embodiments, the transmission shifter includes wherein the bracket assembly includes a top plate, wherein the top plate includes an aperture to enable the gear shifter to be coupled to the shifter mechanism.

In some embodiments, the transmission shifter includes wherein the shifter mechanism is an original equipment mechanism.

In some embodiments, the transmission shifter includes wherein the locking mechanism extends through the front plate to fix the location of the shifter assembly with the support assembly.

In another embodiment, there is provided a vehicle adapted to transport a physically limited person, wherein a front passenger compartment includes a dash, a driver side compartment, and a passenger side compartment. The vehicle includes a support assembly coupled to a vehicle support, wherein the support assembly includes a support bracket having one of a slot and a rail. A shifter assembly includes a locking mechanism and a front plate including the other of the slot and the rail. The slot engages the rail to enable sliding movement of the shifter assembly with respect to the support assembly. The locking mechanism fixes the location of the shifter assembly with respect to the support assembly.

In some embodiments, the vehicle includes wherein the support bracket includes a slot, and the locking mechanism includes a latch block located on a first side of the support bracket, and a slide block located on a second side of the support bracket. The locking mechanism adjusts a position of the slide block with the latch block.

In some embodiments, the vehicle includes wherein the locking mechanism includes a shaft extending through the slide block, through the slot, and through a tee nut block. Adjustment of the arm adjusts a distance between the slide block and the tee nut block to clamp and unclamp the shifter assembly with respect to the dash.

In some embodiments, the vehicle further includes a shifter housing adapted to support a gear shifter coupled to a cable, wherein the support bracket includes a cutout adapted to provide access for the cable.

In some embodiments, the vehicle includes wherein the gear shifter is an original equipment manufacturer part.

In some embodiments, the vehicle further includes a relatively planar floor located at the driver side compartment, wherein the relatively planar floor is configured to accommodate a driver seated in a wheelchair.

In some embodiments, the vehicle further includes a bracket assembly fixedly connected to the front plate, wherein the bracket assembly is configured to support a shifter mechanism coupled to a gear shifter.

In some embodiments, the vehicle further includes a shifter housing connected to the bracket assembly, wherein the shifter housing supports the gear shifter, the shifter mechanism, and the bracket assembly.

In some embodiments, the vehicle includes wherein the bracket assembly includes a top plate, and the top plate includes an aperture to enable the gear shifter to be coupled to the shifter mechanism.

In a further embodiment, there is provided a method of retrofitting an original equipment manufacturer (OEM) vehicle to provide clearance space for a passenger of the vehicle confined to a wheelchair. he method includes: removing a shifter mechanism from the OEM vehicle; attaching a first bracket, defining one of a first slot or a first rail, to an OEM support structure of the OEM vehicle; attaching the shifter mechanism to a shifter support structure, the shifter support structure including a second bracket having the other of the first slot or the first rail; attaching an enclosure to the shifter support structure; slidingly attaching the first bracket to the second bracket by engaging the first slot to the first rail; and fixing the location of the enclosure with respect to the first rail by actuation of a locking mechanism.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates an elevational side view of a sport utility vehicle including an access ramp.

FIG. 2 illustrates a perspective view toward a front passenger compartment of a sport utility vehicle including an individual seated in a wheelchair located at a driver's position.

FIG. 3 illustrates a positionable shifter assembly located adjacently to a front dash of a vehicle.

FIG. 4 illustrates a left-side perspective view of a positionable shifter assembly including a shifter.

FIG. 5 illustrates an underneath left-side perspective view of a positionable shifter assembly.

FIG. 6 illustrates a left-side perspective view of a positionable shifter assembly without a housing.

FIG. 7 illustrates an underneath left-side view of a positionable shifter assembly.

FIG. 8 illustrates a perspective view of a support bracket, a guide bracket, and an actuator of a positionable shifter assembly.

FIG. 9 illustrates a perspective view of a guide bracket, a latch block, and a clamp having a slide block.

FIG. 10 illustrates a perspective view of a guide bracket, a latch block, and a clamp without the slide block of FIG. 9.

FIG. 11 illustrates another embodiment of a left side bottom perspective view of a shifter assembly.

### DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

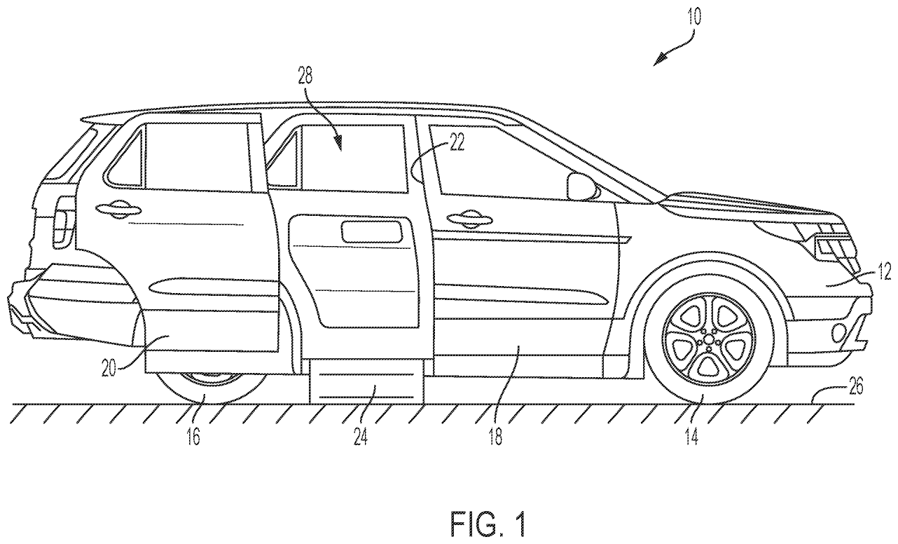

FIG. 1 illustrates a sport utility vehicle (SUV) 10 available from any number of United States and foreign manufacturers. In the illustrated embodiment, the SUV, also called a crossover vehicle, may include a unibody construction, but other SUV's having a frame on body construction, are also included in the present disclosure. Consequently, the use of SUV herein includes all types and kinds of sport utility vehicles constructed with a body on frame construction, a unibody construction, or other constructions. In addition, while the SUV is illustrated in FIG. 1, the present disclosure is directed to all passenger vehicles carrying one or more passengers.

FIG. 1 illustrates the SUV 10 including a body 12 operatively coupled to front wheels 14 and rear wheels 16. The SUV 10 includes a unibody construction. A first passenger side door 18 is located between the front wheels 14 and rear wheels 16 and provides access to a passenger for sitting in a front seat of the vehicle adjacent to the driver.

The SUV 10 has been modified to include a second passenger side door 20 coupled to the unibody frame through a mechanical linkage (not shown). In other embodiments, the side door 20 is coupled to the unibody frame through a sliding mechanism. In this embodiment, the second passenger side door has been modified to slide along a track (not shown) as opposed to the manufacturer supplied door which is hinged to swing away from the vehicle, as is understood by those skilled in the art. In addition to modifying the door 20 to slide along the track, an opening 22 to the interior, in some embodiments, is modified or widened to provide access to a passenger seated in a wheelchair. The opening is defined on the sides thereof by an edge of the door 20 and the edge of the door 18. The vehicle is further modified to include a ramp assembly 24 which provides rolling access of the wheelchair from pavement 26 into an interior 28 of the vehicle 10. The ramp assembly 24 is installed at the opening 22 and is movable between the interior of the vehicle, where it is stored in some embodiments, and to the exterior for wheelchair access.

In known modified vehicles, such as modified vans, the middle row of seats is removed from the manufacturer supplied vehicle to enable access to a passenger using a wheelchair. Once the wheelchaired passenger moves into the interior of the vehicle, the passenger or a caregiver locates the wheelchair in the middle portion of the interior behind the driver and passenger seats of the front row. While the wheelchaired passenger is readily and safely transported by the vehicle when located at this position, the passenger can also move from the middle portion the driver's compartment to drive the vehicle. As used herein, wheelchaired passenger is used to indicate that the individual is making use of a wheelchair, whether that use is temporary or permanent.

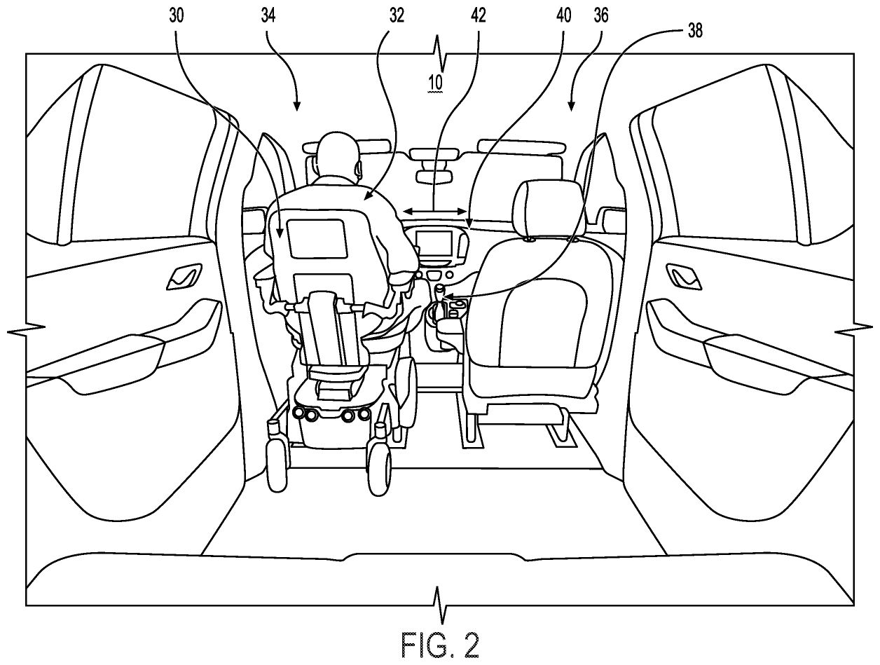

Over the past few years, the number of wheelchaired individuals who desire to lead full active lives has increased. To accommodate such individuals, the SUV has become a preferred vehicle of choice, particularly with military veterans who received disabilities during their tours of duty. Consequently, the SUV 10 is further modified or retrofitted as illustrated in FIG. 2 to provide a location having sufficient space for the wheelchaired passenger to be located in the driver's side position to drive the vehicle 10.

To retrofit the vehicle 10, an SUV is purchased from a dealer or directly from the manufacturer and the driver's side seat is removed from the vehicle to provide an area for the driver to be seated behind the steering wheel. In one embodiment as shown in FIG. 2, the floor of the front passenger compartment may be retrofitted to provide a relative planar floor adapted to support a wheelchair 30 supporting a driver 32. A driver side location 34 and a passenger side location 36 may be located in a front passenger compartment on either side of a positionable shifter assembly 38, which is located at a front dash 40, also known as a dashboard or instrument panel, of the vehicle 10. In this embodiment, the shifter assembly 38 may be configured to move along an axis 42, or side to side, from the driver side location 34 to the passenger side location 36, and back. By moving the shifter assembly from side to side, additional clearance space for a driver in a wheelchair is provided.

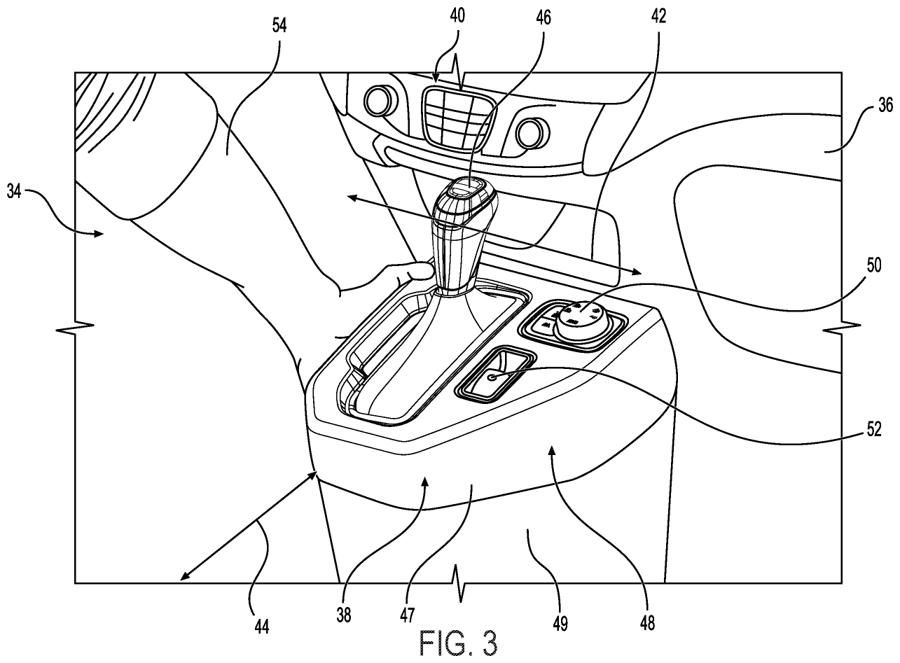

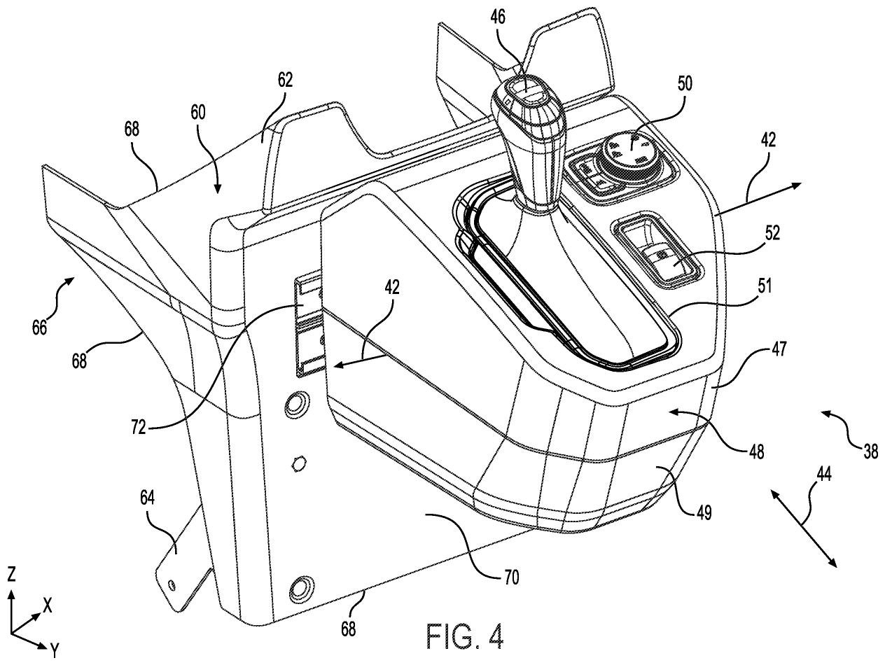

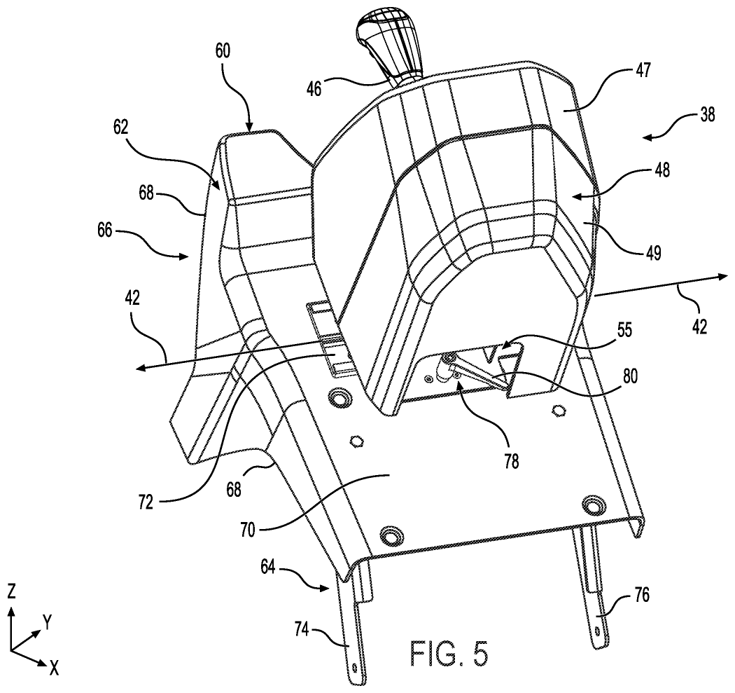

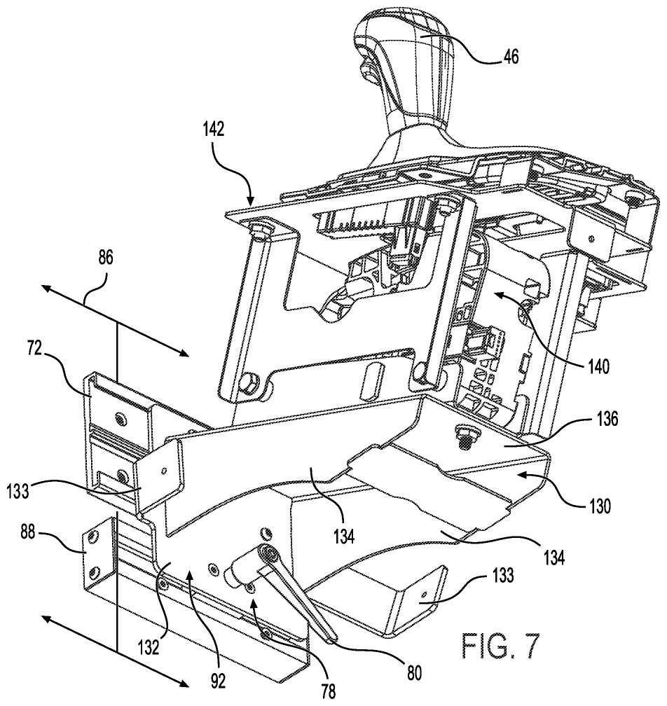

In FIG. 3, the shifter assembly 38 is shown in perspective and may be configured to slide laterally along the axis 42 and along the front dash 40. This axis 42 is generally perpendicular to a longitudinal axis 44 that extends along the length of the vehicle. The shifter assembly 38 may include a gear shifter 46 that extends from a housing 48 that includes a first part 47 and a second part 49. The first part 47 can mate to the second part 49 to provide an enclosure, or a surround, enclosing a shifter mechanism 140 (see FIG. 7). The gear shifter 46 of the shifter mechanism 140 extends through an aperture 51 of the first part 47 as seen in FIG. 4. A selector knob 50 may also be located at the first part 47 and allows the user to select traction control modes as is understood by those skilled in the art. A parking brake switch 52 at the first part 47 provides for setting and releasing a parking brake. The shifter assembly 38 may include an adjustment mechanism, as described later herein, that when released enables a user 54 to move the assembly 38 side to side by applying sufficient pressure on either side of the housing 48. The adjustment mechanism in may include a handle 80 that extends through a cutout 55. (See FIG. 5) In one embodiment, the shifter assembly 38 may be movable at a distance of approximately 2.5 inches on either side of a center position. In other embodiments, distances both more or less than 2.5 inches may be possible.

In one embodiment, the shifter assembly 38 may slide along the axis 42 toward or away from the driver or front passenger and may be securable at a selected position. The adjustment mechanism of the shifter assembly 38 may provide for additional clearance for wheelchair occupants seated in the front seating positions. This feature, not only provides improved access to the shifter by the driver, but can also enhance the driver's comfort and driving experience.

In the illustrated embodiment of FIG. 4, a left side perspective view is shown of a support assembly 60 to which the assembly 38 may be coupled. The support assembly 60 may include a panel 62 and a support element 64 which is operatively connected to a part of the OEM vehicle structure that supports structures of the vehicle dash 40. In one embodiment, the panel 62 as well as the support element 64 are not original equipment parts, but are new after-market parts. The housing 38, likewise, may also not be an original equipment part, but is a new after-market part. The panel 60, in particular, while not an OEM part may be configured to match the OEM parts of the dash to which it is connected. For instance, in one embodiment, the panel 60 may include a perimeter 66 defining edges 68 that meet or mate with surfaces or edges of the OEM dash to provide a relatively gap-free interface when mated to the OEM dash. The interface, in one embodiment, may have the appearance of a relatively seamless interface. A center portion of the OEM dash may be removed and the support element 64 and the panel 60 are located in its place. OEM components may be removed and replaced with original components that are designed to mate with an existing OEM structure at the top of the dash and with a lowered floor structure of the modified vehicle at the bottom via a first arm 74 and a second arm 76 of FIG. 5.

In a further embodiment, the panel 62 may include a relatively planar front face 70 to which a guide bracket 72 is coupled. As further shown in a left side bottom perspective view of FIG. 5, the support element 64 may include the first arm 74 and the second arm 76 configured to connect to the OEM vehicle support structure. The shifter assembly 38 may slide along the guide bracket 72 when released for movement by actuation of a clamp 78, part of the adjustment mechanism, which in one embodiment, includes a handle 80. The handle 80 may operate as an adjustment lever, which when loosened enables the shifter assembly 38 to move side to side and when tightened fixes the shifter assembly 38 in a selected location along the guide bracket 72.

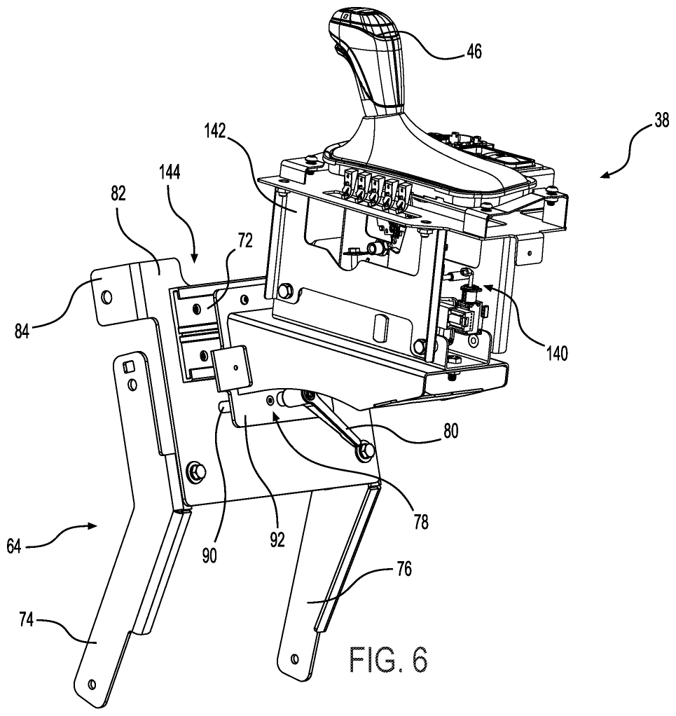

FIG. 6 illustrates a left side bottom perspective view of the shifter assembly 38, absent the housing 48, and the support assembly 60, lacking the panel 62. The support assembly 60 may include the support element 64 and a support bracket 82 connected to the support element 64. The support bracket 82 may include wings 84, one of which is shown, which connects to center dash supports. The panel 62 may be located between the support bracket 82 and the guide bracket 72, the position of which is shown in FIG. 7.

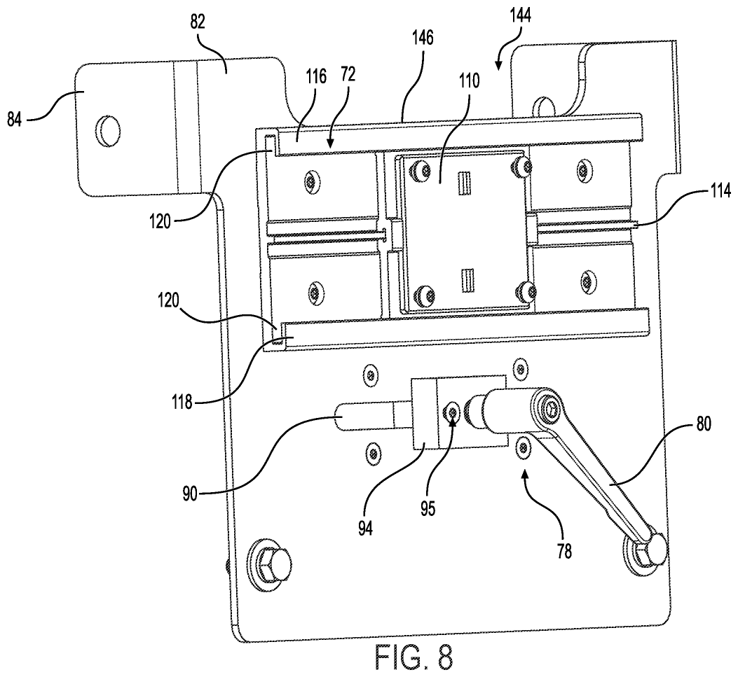

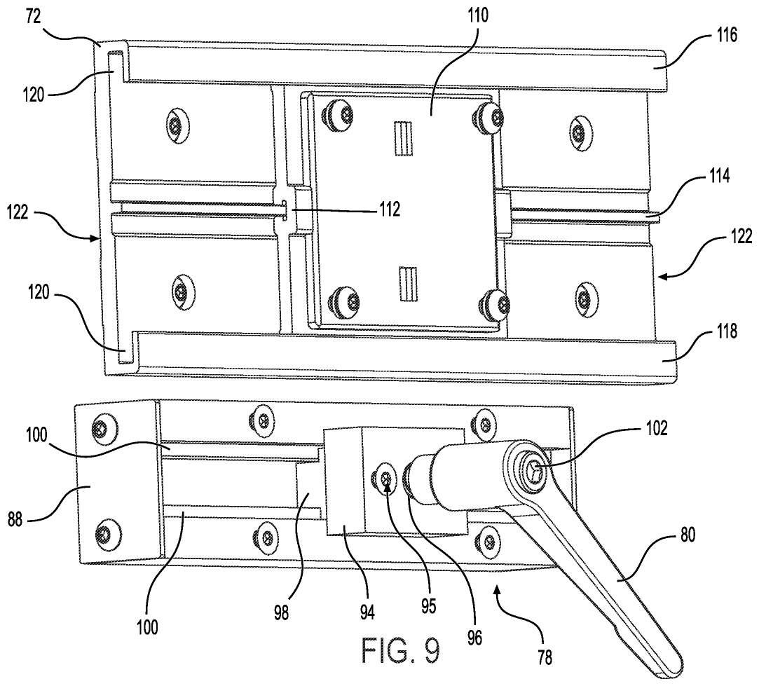

In FIG. 7, the location of the panel 62 is shown by a plane 86 to indicate that the guide bracket 72 may be located on one side of the panel 62 and a latch block 88 may be located on the opposite side of the panel 62. The latch block 88 may be fixedly connected to the support bracket 82 which includes a slot 90 (see FIG. 6) configured to receive the clamp 78 and parts thereof. The clamp 78 may extend through a shifter housing 92 and includes a slide block 94, as shown in FIGS. 8 and 9, which may be located on the opposite side of shifter housing 92 (not illustrated in FIG. 8).

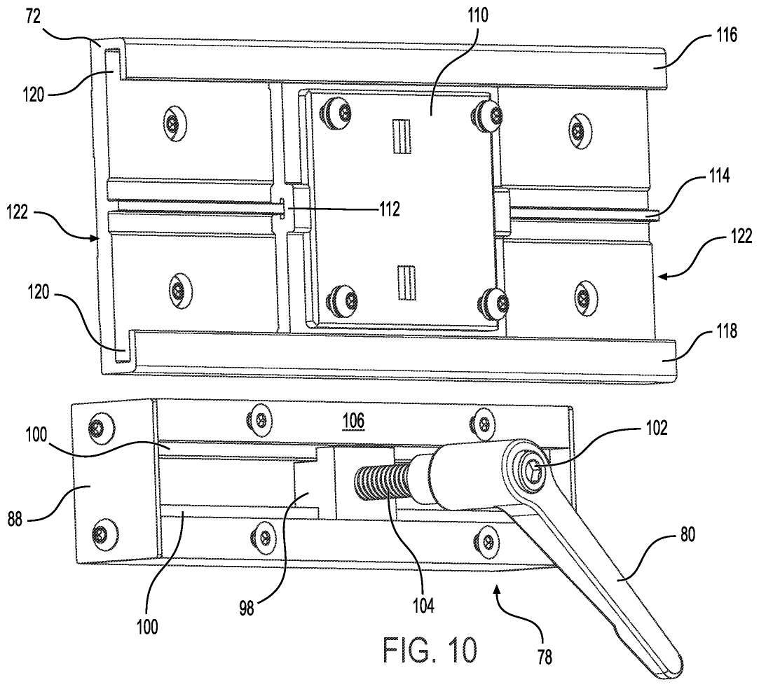

In the embodiment of FIG. 9, a shaft 96, coupled to the handle 80, may extend through the slide block 94 and into a tee nut block 98 that slides on linear rails 100 of the latch block 88. Rotation of the handle 80 about a handle axis 102 can fix or loosen the assembly 38 at a user selected position. As further shown in FIG. 10, the slide block 94 may be removed to show screw threads 104, that adjusts the position of the slide block 94 with respect to a surface 106 of the latch block 88, which may be located behind support bracket 82. While slide mechanisms are disclosed herein, other mechanisms to enable movement of the assembly 38 with respect to the vehicle dash 40 are contemplated. For instance, in one embodiment, a four-bar mechanism is coupled to the assembly 38 and to a supporting structure attached to the vehicle dash 40.

In one embodiment, the slide block 94 may be fixedly coupled to the shifter housing 92 by connectors 95, such as bolts or screws. In other embodiments, other connectors may be used. The screw threads 104 (See FIG. 10) may extend into the tee nut block 98, as also shown in FIGS. 8 and 9. When handle 80 is rotated to tighten clamp 78, i.e., clockwise as illustrated, the slide block 94, and consequently shifter housing 92 to which the slide block is connected, may be pulled toward the support bracket 82 of FIG. 6. When sufficiently tightened, the assembly 38 may be fixed in position and does not shift left or right.

While the clamp 78 is used to fix the location of the slide block 94 and consequently the shifter assembly 38, other locking mechanisms are contemplated to fix the location of the shifter assembly. For instance in one embodiment, a spring biased pin that engages in one of a grid of apertures is used to fix the location of the shifter assembly. In another embodiment, a spring biased lever including one or more projections engages indentions located on a locating strip. See U.S. Pat. No. 9,227,511, the contents of which are incorporated by reference herein in its entirety.

When the shifter assembly 38 is located at a position desired by the driver, passenger, or other individual, the handle 80 may be rotated to clamp the shifter assembly into place.

In an embodiment shown in FIG. 10, a slide plate 110 may be attached to a side of the shifter housing 92 facing the guide bracket 72 to provide additional sliding structural support. The slide plate 110 may include a linear slot 112 configured to engage a linear rail 114 of the guide bracket 72. In one embodiment, the guide bracket 72 may include a first flange 116 and a second flange 118. Each of the first flange 116 and the second flange 118 may define a slot 120 that engage edges of the slide plate 110. Due to the overlapping construction of the slots 120 with the slide plate 110, the slide plate 110 may be inserted into the guide bracket 72 from one of the ends 122 thereof (see also FIGS. 8 and 9). In another embodiment, the slide plate 110 may include a linear rail and the guide bracket may include a linear slot to engage the linear rail of the slide plate.

Returning to the embodiment of FIG. 7, the shifter housing 92 may include a shelf support 130 which in different embodiments may be coupled to a front plate 132 to which the slide plate 110 is attached. The front plate 132 may include ears 133 to which the second part 49 of the shifter assembly 38 may be attached. Side walls 134 of the shelf plate 130 can provide structural support to a top plate 136. A shifter mechanism 140, that includes the shifter 46, selector knob 50 and parking brake switch 52, may be located at a bracket assembly 142 configured to support the shifter mechanism. The bracket assembly 142 includes a top plate 143 having an aperture 145. The shifter mechanism 140 may be an OEM part and the bracket assembly may be an after-market part designed to support the shifter mechanism 140 at the shelf support 130 for sliding movement of the completed shifter assembly 38.

In another embodiment, the shifter mechanism 140 may include a wiring harness (not shown) that connects to a vehicle wiring harness as understood by those skilled in the art. As the shifter assembly 38 moves from side to side, the wiring harness extending from the shifter assembly 38 may also move as well. To accommodate access for the wiring harness and this movement, the support bracket 82 may include a cutout 144 (See, e.g., FIGS. 6 and 8). A top surface 146 of the first flange of guide bracket 72 may be disposed at the cutout 144 to reduce or eliminate abrasion to the wiring harness which could result in damage.

As described herein, the shifter assembly 38 may include both OEM parts and aftermarket parts assembled to provide an adjustable transmission assembly. By using OEM vehicle control components along with the described after-market parts and assemblies, a vehicle operator seated in wheelchair may be provided with a vehicle having enhanced features. The OEM vehicle may be improved, while still maintaining a look and feel of the original vehicle. Vehicle and driver safety may be also improved by providing additional room for the vehicle operator seated in a wheelchair. Likewise, should the vehicle operator not be seated in a wheelchair, the shifter assembly 38 can be moved toward the driver to provide more room for a front row passenger seated in a wheelchair.

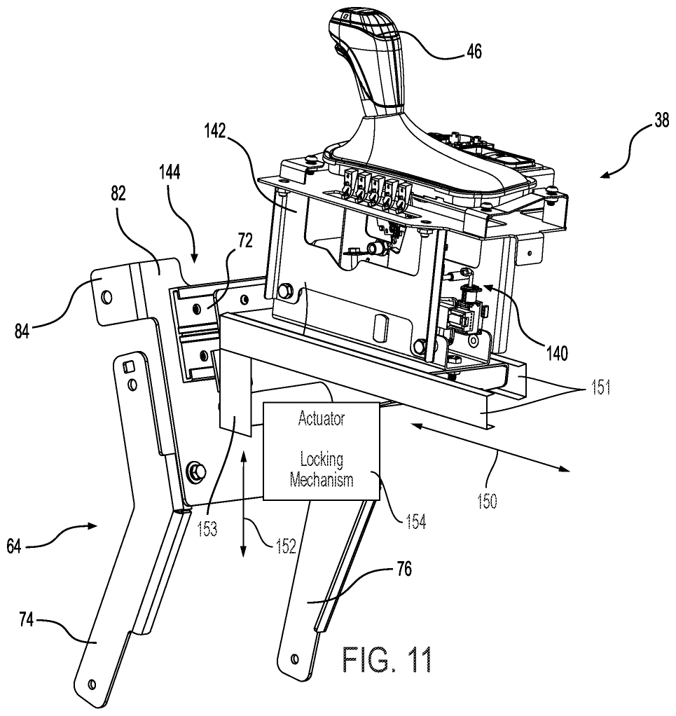

FIG. 11 illustrates another embodiment of a left side bottom perspective view of the shifter assembly 38, absent the housing 48, and the support assembly 60, lacking the panel 62. The support assembly 60 may include the support element 64 and a support bracket 82 connected to the support element 64. The support bracket 82 may include wings 84, one of which is shown, which connects to center dash supports. The panel 62 may be located between the support bracket 82 and the guide bracket 72, the position of which is shown in FIG. 7. In this embodiment, the shifter assembly 38 is adjustable along the previously identified axis 42 of FIG. 6, as well as along one or both of a longitudinal 150 and a vertical axis 152. Rails 151 enable movement of the shifter assembly 38 along the axis 150 in a forward-rearward direction with respect to the length of the vehicle. Rails 153 enable movement of the shifter assembly 38 of the assembly along an up-down direction which respect to the floor and the ceiling. Each of the movements along any of the axis 42, 150, and 152 are independent of the other axis of movement to enable positioning of the assembly 38 along any of the three axis. By providing adjustable movement of the assembly 38 along any of the three axis, the position of the assembly 38 accommodates a wide variety of users and wheelchairs or other assistance devices for a physically limited user. While the assembly 38 of FIG. 11 illustrates the position of the assembly 38 along any one of the three axis, in other embodiments, any one of the other positioning assemblies as described herein are configured to include mechanisms to enabling at least three degrees of movement. See also U.S. Pat. No. 9,227,511 describing movement along a forward-rearward direction.

FIG. 11 further includes a sliding and locking mechanism 154 including an actuator and a locking mechanism. In this embodiment, the actuator provides for movement of the shifter assembly 38 along any of the three axis provided by electrically or hydraulically powered actuators, i.e. positioning devices, such as a motor, a hydraulic pump, or other devices. With the use of these positioning devices, the user is not required to apply a physical force to move the shifter assembly. Instead, movement of the shifter assembly is made in response to the user activating a button, toggle, or joystick that causes the positioning devices to adjust the position of the actuator. Other activating devices are contemplated, including but not limited to touch screen devices.

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A transmission shifter for a vehicle having a dash, the transmission shifter comprising:
a support assembly coupled to a vehicle support, the support assembly including a support bracket having one of a slot and rail;
a shifter assembly including a locking mechanism and a front plate including the other of the slot and the rail, wherein the slot engages the rail to enable sliding movement of the shifter assembly with respect to the support assembly, and the locking mechanism fixes the location of the shifter assembly with respect to the support assembly.

2. The transmission shifter of claim 1, wherein the support bracket includes a slot, wherein the locking mechanism includes a latch block located on a first side of the support bracket, and a slide block located on a second side of the support bracket, wherein the locking mechanism adjusts a position of the slide block with respect to the latch block.

3. The transmission shifter of claim 2 wherein the locking mechanism includes a shaft extending through the slide block, through the slot, and through a tee nut block, wherein adjustment of the arm adjusts a distance between the slide block and the tee nut block to clamp and unclamp the shifter assembly with respect to the dash.

4. The transmission shifter of claim 3 further including a shifter housing is adapted to support a gear shifter coupled to a cable, wherein the support bracket includes a cutout adapted to provide access for the cable.

5. The transmission shifter of claim 4 wherein the gear shifter is an original equipment manufacturer part.

6. The transmission shifter of claim 1 further comprising a bracket assembly fixedly connected to the front plate, the bracket assembly being configured to support a shifter mechanism coupled to the gear shifter.

7. The transmission shifter of claim 6 further comprising a shifter housing connected to the bracket assembly, wherein the shifter housing supports the gear shifter, the shifter mechanism, and the bracket assembly.

8. The transmission shifter of claim 7 wherein the bracket assembly includes a top plate, wherein the top plate includes an aperture to enable the gear shifter to be coupled to the shifter mechanism.

9. The transmission shifter of claim 8 wherein the shifter mechanism is an original equipment mechanism.

10. The transmission shifter of claim 8 wherein the locking mechanism extends through the front plate to fix the location of the shifter assembly with the support assembly.

11. A vehicle adapted to transport a physically limited person, wherein a front passenger compartment includes a dash, a driver side compartment, and a passenger side compartment, the vehicle comprising:
a support assembly coupled to a vehicle support, the support assembly including a support bracket having one of a slot and a rail;
a shifter assembly including a locking mechanism and a front plate including the other of the slot and the rail, wherein the slot engages the rail to enable sliding movement of the shifter assembly with respect to the support assembly, and the locking mechanism fixes the location of the shifter assembly with respect to the support assembly.

12. The vehicle of claim 11, wherein the support bracket includes a slot, wherein the locking mechanism includes a latch block located on a first side of the support bracket, and a slide block located on a second side of the support bracket, wherein the locking mechanism adjusts a position of the slide block with the latch block.

13. The vehicle of claim 12 wherein the locking mechanism includes a shaft extending through the slide block, through the slot, and through a tee nut block, wherein adjustment of the arm adjusts a distance between the slide block and the tee nut block to clamp and unclamp the shifter assembly with respect to the dash.

14. The vehicle of claim 13 further including a shifter housing adapted to support a gear shifter coupled to a cable, wherein the support bracket includes a cutout adapted to provide access for the cable.

15. The vehicle of claim 14 wherein the gear shifter is an original equipment manufacturer part.

16. The vehicle of claim 14 further comprising a relatively planar floor located at the driver side compartment, the relatively planar floor configured to accommodate a driver seated in a wheelchair.

17. The vehicle of claim 11 further comprising a bracket assembly fixedly connected to the front plate, the bracket assembly being configured to support a shifter mechanism coupled to a gear shifter.

18. The vehicle of claim 17 further comprising a shifter housing connected to the bracket assembly, wherein the shifter housing supports the gear shifter, the shifter mechanism, and the bracket assembly.

19. The vehicle of claim 18 wherein the bracket assembly includes a top plate, wherein the top plate includes an aperture to enable the gear shifter to be coupled to the shifter mechanism.

20. A method of retrofitting an original equipment manufacturer (OEM) vehicle to provide clearance space for a passenger of the vehicle confined to a wheelchair, the method including;
removing a shifter mechanism from the OEM vehicle;
attaching a first bracket, defining one of a first slot or a first rail, to an OEM support structure of the OEM vehicle;
attaching the shifter mechanism to a shifter support structure, the shifter support structure including a second bracket having the other of the first slot or the first rail;
attaching an enclosure to the shifter support structure;
slidingly attaching the first bracket to the second bracket by engaging the first slot to the first rail; and
fixing the location of the enclosure with respect to the first rail by actuation of a locking mechanism.
